(19) United States
(12) Patent Application Publication
(10) Pub. No.: US 2025/0385728 A1
(43) Pub. Date: Dec. 18, 2025

(54) NON-TERRESTRIAL NETWORK UTILIZATION DURING TERRESTRIAL NETWORK CONGESTION

(71) Applicant: T-MOBILE INNOVATIONS LLC, Overland Park, KS (US)

(72) Inventor: Gaviphat LEKUTAI, Kirkland, WA (US)

(21) Appl. No.: 18/744,287

(22) Filed: Jun. 14, 2024

(51) Int. Cl. H04B 7/185

(52) U.S. Cl. CPC H04B 7/18513

(57) ABSTRACT

Systems and methods for offloading or switching between terrestrial and non-terrestrial radio access networks (RANs) are provided. Based on a determination that a utilization of a terrestrial base station exceeds a pre-determined threshold, a UE is instructed to connect to one or more nodes of a non-terrestrial network. The UE is instructed to communicate with the non-terrestrial network. The UE may maintain a connection with the terrestrial base station, such as to switch back and forth between the networks, or it may disconnect from the base station in favor of the non-terrestrial connection.

### SUMMARY

The present disclosure is directed to connecting, offloading, and/or switching between a terrestrial network and a non-terrestrial network, substantially as shown and/or described in connection with at least one of the Figures, and as set forth more completely in the claims.

According to various aspects of the technology, systems and methods of diverting a portion of network traffic from a congested base station of a terrestrial network to a non-terrestrial network are provided. Non-terrestrial networks will be increasingly integrated with conventional cellular telecommunication networks. In order to communicate with a wide range of user equipment (UE), it is most likely that nodes of non-terrestrial networks (e.g., satellites) will be deployed with hardware and software configurations that utilize existing cellular telecommunication frequency bands to communicate with UEs at or near the ground. Such integration, along with the resultant overlapping coverage areas, presents the opportunity to divert a portion of network traffic from a terrestrial network to a non-terrestrial network to reduce congestion. Traffic diversion may include a total offload of the UE to the non-terrestrial network or may include switching between each network at designated time periods, providing improved network performance for all subscribers by reducing congestion at a terrestrial RAN node.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary computing device for use with the present disclosure;

FIG. 2 illustrates a diagram of an exemplary environment in which implementations of the present disclosure may be employed;

FIG. 3 depicts a flow diagram of an exemplary method for offloading terrestrial connections from a terrestrial radio access network (RAN) to a non-terrestrial RAN, in accordance with embodiments described herein; and

FIG. 4 depicts a flow diagram of an exemplary method for switching between a terrestrial RAN and a non-terrestrial RAN, in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, the provision of telecommunication services is moving beyond the surface of the earth at increasing speed. Network operators, once exclusively operating terrestrial base stations, will begin to utilize non-terrestrial network (NTN) systems (e.g., drones, satellites) to provide coverage to areas unserved or underserved by terrestrial base stations; they may also be used to expand coverage to the same areas served by terrestrial base stations. Existing terrestrial base stations frequently experience heavy traffic and congestion which may impact network performance and may cause excessive UEs to be rejected from attaching to a particular base station. Such reduced performance may cause delays in communication, reduced data throughput, and potential disruptions in service for users. Systems and methods seeking to improve network performance for all subscribers in the event of network congestion are employed to assist in reducing this congestion.

Conventionally, when a particular base station is facing congestion, the base station may deploy congestion reduction mechanisms. Congestion reduction mechanisms may include deploying carrier aggregation and/or diverting a portion of network traffic to other base stations, cells, and/or networks. For example, when a 5G base station (gNB) is facing congestion, it may elect to handover some connections to a 4G base station (eNB). However, conventional congestion reduction or traffic diversion mechanisms are insufficient to resolve congestion caused by increased network traffic, as these base stations and/or networks receiving the portion of network traffic may similarly face congestion such that they are unable to receive additional connections from another base station. In these events, the congested base station may have nowhere to send at least a portion of its connections in order to reduce its congestion, as all nearby base stations and/or networks are at or near full capacity.

In order to improve network performance for subscribers in the event all nearby base stations are congested, and in contrast to conventional solutions, the present disclosure is directed to diverting a portion of terrestrial base station traffic to a non-terrestrial network to provide improved network performance for subscribers. Once a utilization of the terrestrial base station exceeds a pre-determined threshold, one or more network components may instruct a UE to connect to one or more nodes of the non-terrestrial network, such as a satellite. In some aspects, the UE may be instructed to switch back and forth after expiration of different time periods between a connection with the base station and a connection with the non-terrestrial network. In other aspects, the UE may be instructed to connect to the NTN and disconnect from the base station. By providing a non-terrestrial network to offload to or switch between, overall network performance is improved, reducing disruptions of service to subscribers.

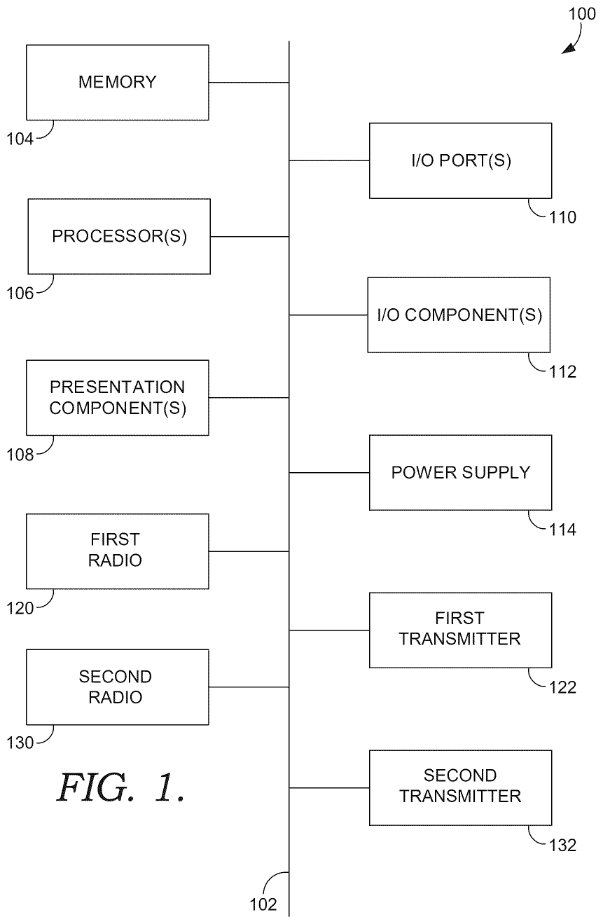

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, 6G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

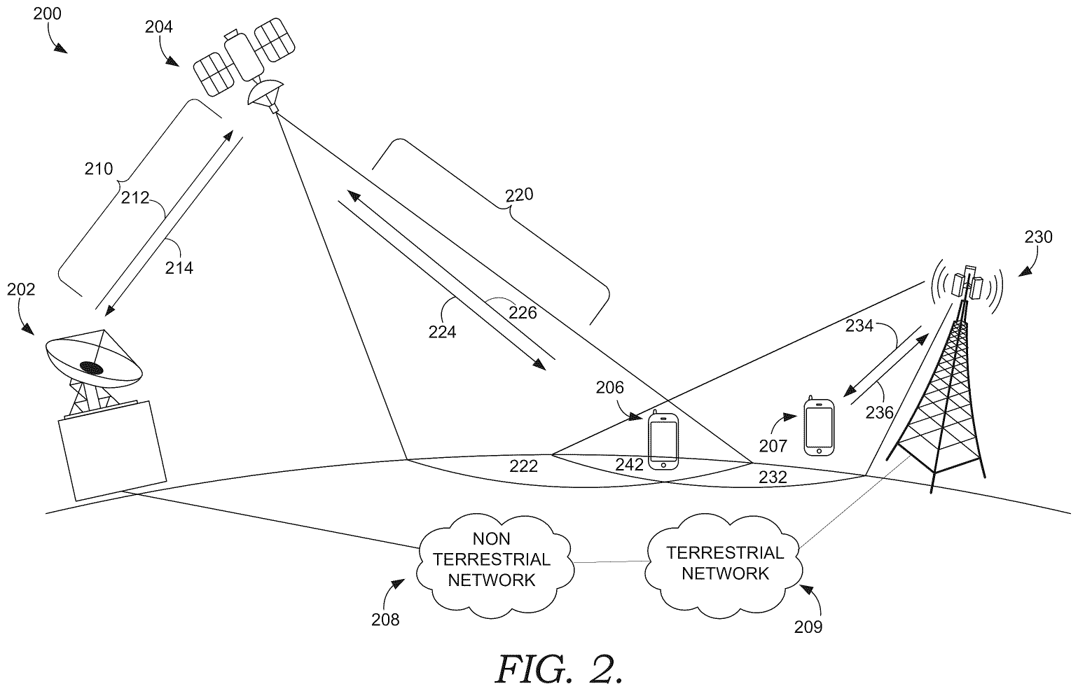

Turning now to FIG. 2, an exemplary network environment is illustrated in which implementations of the present disclosure may be employed. Such a network environment is illustrated and designated generally as network environment 200. At a high level the network environment 200 comprises a gateway 202, a non-terrestrial node 204 of a non-terrestrial radio access network (RAN) 208 (i.e., non-terrestrial network 208), one or more UEs (e.g., a first UE 206 and/or a second UE 207), and a terrestrial base station 230 of a terrestrial RAN 209 (i.e., terrestrial network 209). Though the composition of network environment 200 illustrates some objects in the singular, it should be understood that more than one of each component is expressly conceived as being within the bounds of the present disclosure; for example, the network environment 200 may comprise multiple gateways, multiple non-terrestrial nodes that communicate with a single gateway, multiple terrestrial base stations, and the like.

The network environment 200 includes one or more UEs, such as the first UE 206 and/or the second UE 207. In aspects, the first UE 206 and/or the second UE 207 are non-terrestrial network compatible UEs. Though the first UE 206 and a second UE 207 are illustrated as cellular phones, a UE suitable for implementations with the present disclosure may be any computing device having any one or more aspects described with respect to FIG. 1.

The network environment 200 includes a gateway 202 communicatively connected to the non-terrestrial network 208 and the non-terrestrial node 204. The gateway 202 may be connected to the non-terrestrial network 208 via one or more wireless or wired connections and is connected to the non-terrestrial node 204 via a feeder link 210. The gateway 202 may take the form of a device or a system of components configured to communicate with the first UE 206 via the non-terrestrial node 204 and to provide an interface between the non-terrestrial network 208 and the non-terrestrial node 204. Generally, the gateway 202 utilizes one or more antennas to transmit signals to the non-terrestrial node 204 via a forward uplink 212 and to receive signals from the non-terrestrial node 204 via a return downlink 214. The gateway 202 may communicate with a plurality of non-terrestrial nodes, including the non-terrestrial node 204.

The network environment 200 includes one or more non-terrestrial nodes, represented by non-terrestrial node 204. The non-terrestrial node 204 may take various forms (e.g., satellites, drones, aircrafts, high altitude platforms, and the like). The non-terrestrial node 204 is generally configured to relay communications between the gateway 202 and one or more UEs, such as the first UE 206. The non-terrestrial node 204 communicates with the gateway 202 using the feeder link 210 and communicates with the first UE 206 using a user link 220. The user link 220 comprises a forward downlink 224 used to communicate signals from the non-terrestrial node 204 to the first UE 206 and a return uplink 226 used to communicate signals from the first UE 206 to the non-terrestrial node 204. The non-terrestrial node 204 may communicate with the first UE 206 using any wireless telecommunication protocol desired by a network operator, including but not limited to 3G, 4G, 5G, 6G, 802.11x and the like. Though shown as having a single beam providing coverage to a non-terrestrial coverage area 222, the non-terrestrial node 204 may be configured to utilize a plurality of individual beams to communicate with multiple different areas at or near the same time. Similarly, though a single forward downlink 224 and a single return uplink 226 are illustrated, the first UE 206 may utilize multiple downlinks and/or multiple uplinks to communicate with the non-terrestrial node 204, using any one or more frequencies as desired by a network operator.

In some aspects, the non-terrestrial node 204 is a satellite having an orbit around the Earth. The orbit of any particular satellite will vary by operator desire and/or intended use. For example, a satellite suitable for use with the present disclosure may be characterized by its maximum orbital altitude and/or orbital period as Low Earth Orbit (LEO), Medium Earth Orbit (MEO), and High Earth Orbit (HEO). In such aspects, the orbit of the non-terrestrial node 204 may proceed such that the first UE 206 is no longer within the non-terrestrial coverage area 222, but the first UE 206 may now be within a coverage area of another non-terrestrial node of the non- terrestrial network 208. In such aspects, the first UE 206 may be handed over from the non- terrestrial node 204 to the other non-terrestrial node to preserve the connection to the non-terrestrial network 208.

The network environment 200 includes one or more non-terrestrial networks, represented by the non-terrestrial network 208. The non-terrestrial network 208 comprises any one or more public or private networks. The non-terrestrial network 208 may be configured according to one or more network architectures and/or principles, such as conventional RAN, cloud-based RAN, and/or open RAN technologies. In some aspects, the non-terrestrial network 208 may be configured as a satellite network connecting to a plurality of gateways, such as the gateway 202. A UE, such as the first UE 206 may communicate with the non-terrestrial network 208 via one or more non-terrestrial nodes, such as the non-terrestrial node 204. In aspects, the non-terrestrial network 208 utilizes a first frequency range to communicate with one or more UEs (e.g., the first UE 206).

The network environment 200 includes one or more terrestrial base stations, represented by terrestrial base station 230. The terrestrial base station 230 is generally configured to relay communications between the terrestrial network 209 and one or more UEs, such as the first UE 206 and/or the second UE 207. The terrestrial base station 230 communicates signals to the first UE 206 and/or the second UE 207 using a terrestrial downlink 234 and receives signals from the first UE 206 and/or the second UE 207 using a terrestrial uplink 236. The terrestrial base station 230 may communicate with the first UE 206 and/or the second UE 207 using any wireless telecommunication protocol desired by a network operator, including but not limited to 3G, 4G, 5G, 6G, 802.11x and the like. Though shown as having a single beam providing coverage to a terrestrial coverage area 232, the terrestrial base station 230 may be configured to utilize a plurality of individual beams to communicate with multiple different areas at or near the same time. Similarly, though a single terrestrial downlink 234 and a single terrestrial uplink 236 are illustrated, the first UE 206 and/or the second UE 207 may utilize multiple downlinks and/or multiple uplinks to communicate with the terrestrial base station 230, using any one or more frequencies as desired by a mobile network operator.

The network environment 200 includes one or more terrestrial networks, represented by the terrestrial network 209. The terrestrial network 209 comprises any one or more public or private networks. The terrestrial network 209 may be configured according to one or more network architectures and/or principles, such as conventional RAN, cloud-based RAN, and/or open RAN technologies. In some aspects, the terrestrial network 209 may comprise a cellular telecommunications network (e.g., a 4G, 5G, or 6G core network, an IMS network, and the like), a data network, and/or a publicly switched telephony network (PSTN). A UE, such as the second UE 207, may communicate with the terrestrial network 209 via one or more terrestrial base stations, such as the terrestrial base station 230. In aspects, the terrestrial network 209 utilizes a second frequency range to communicate with one or more UEs (e.g., the first UE 206 and/or the second UE 207). In such aspects, the first frequency range of the non-terrestrial network 208 and the second frequency range of the terrestrial network 209 are different.

In aspects of the present disclosure, there may exist an overlapping coverage area 242, wherein the non-terrestrial coverage area 222 and the terrestrial coverage area 232 at least partially overlap. The non-terrestrial coverage area 222 and the terrestrial coverage area 232 may be determined to at least partially overlap where an edge of the non-terrestrial coverage area 222 is within a predetermined threshold distance of an edge of the terrestrial coverage area 232. One or more UEs, such as the first UE 206 and/or the second UE 207, may be located within the overlapping coverage area 242, such that the one or more UEs may connect to the terrestrial base station 230 and/or the non-terrestrial node 204.

The terrestrial base station 230 may occasionally or frequently experience network traffic beyond its utilization capacity, resulting in congestion of network traffic and an overall reduction in network performance for subscribers connected to the terrestrial base station 230. In these events, a subscriber may experience dropped calls, increased data latency, connectivity issues, and the like. Any UEs subsequently entering the terrestrial coverage area 232 may struggle to access the terrestrial network 209 through the terrestrial base station 230. Conventionally, when the terrestrial base station 230 is experiencing such circumstances, the base station may employ carrier aggregation and/or divert a portion of the network traffic to other base stations and/or other terrestrial networks, such as a handover from a congested 5G base station to a less congested, nearby 4G base station.

Relevant to the present disclosure, a portion of the network traffic may be diverted to the non-terrestrial network 208 by the one or more UEs in the overlapping coverage area 242 (e.g., the first UE 206) connecting to the non-terrestrial node 204. When one or more computer processing components determines a utilization of the base station exceeds a pre-determined threshold, a UE of a plurality of UEs (e.g., the first UE 206) may be instructed to connect to the non-terrestrial node 204. In some aspects, the UE of the plurality of UEs (e.g., the first UE 206) may be further instructed to disconnect from the terrestrial base station 230. In other aspects, the UE may be instructed to remain connected to the terrestrial base station 230 while being connected to the non-terrestrial node 204 and may be further instructed to switch between the two connections. In such aspects, the UE may be instructed to communicate with the non-terrestrial node 204 in a first time period and instruct the UE to communicate with the terrestrial base station 230 in a second time period. In such aspects, the second time period may be subsequent to the first time period.

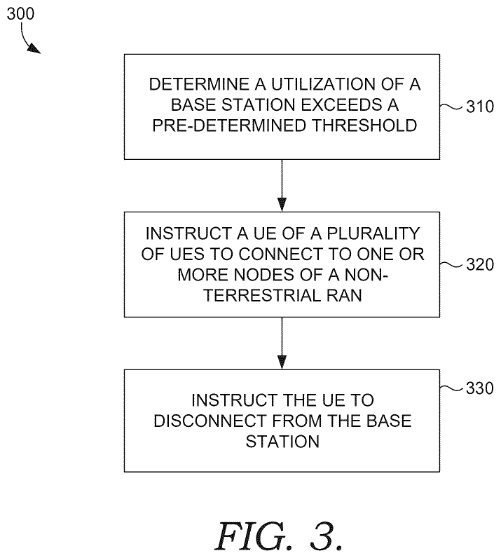

Turning now to FIG. 3, a flow chart representing a method 300 for offloading terrestrial connections from a terrestrial RAN (e.g., the terrestrial network 209 of FIG. 2) to a non-terrestrial RAN (e.g., the non-terrestrial network 208 of FIG. 2) is provided. The method 300 may be incorporated into a system having one or more of the components and/or features described with respect to FIG. 2.

At a first step 310, one or more computer processing components may determine a utilization of a base station (e.g., the terrestrial base station 230 of FIG. 2) exceeds a pre-determined threshold. The utilization of the base station may be determined to exceed a pre-determined threshold based on a performance metric associated with wireless connections between the base station and one or more UEs, and/or based on actual usage of radio frequency resources at the base station.

The utilization of the base station may exceed the pre-determined threshold based on one or more performance metrics associated with a wireless connection. For example, the utilization of the base station exceeding the pre-determined threshold may comprise a signal to interference noise ratio (SINR) being less than a predetermined SINR threshold (e.g., 0, 1, 3, or 5 dB) and/or a reference signal receive quality being (RSRQ) being less than a predetermined RSRQ threshold (e.g., −15, −18, or −20 dB). The utilization of the base station exceeding the pre-determined threshold may comprise one or more KPIs associated with resource utilization exceeding one or more pre-determined resource utilization thresholds, such as a number of resource blocks exceeding a pre-determined resource block threshold. The utilization of the base station may be based on one or more KPIs associated with throughput (e.g., average downlink throughput), data latency, reference signal received power (RSRP), received signal strength indicator (RSSI), and the like.

The utilization of the base station may be based on actual usage of radio frequency resources at the base station. In aspects, the utilization of the base station may be based on a number of sessions or connections of the base station or a number of particular types of sessions. For example, the utilization of the base station may be found to exceed a pre-determined threshold when a number of voice sessions exceeds a pre-determined voice session threshold. The utilization of the base station may be determined by a call setup success rate being less than a pre-determined call setup threshold. The utilization of the base station exceeding the pre-determined threshold may be the result of a threshold change to a particular utilization parameter, such as if the SINR decreases by a threshold amount (e.g., 3 dB). The pre-determined threshold may be set and/or altered by a network operator. Actual usage information may also be based on a number (or percentage) of allocated/used resource blocks compared to a total available number of resource blocks or an amount of allocated/used spectrum compared to a total available spectrum.

In a second step 320, the one or more computer processing components may instruct a UE (e.g., the first UE 206 of FIG. 2) of a plurality of UEs to connect to one or more nodes of the non-terrestrial RAN (e.g., the non-terrestrial network 208 of FIG. 2). The UE may be instructed by receiving a radio control channel (RRC) connection message requesting the UE alter or switch its spectrum from that of the terrestrial RAN to that of the non-terrestrial RAN. In some aspects, the one or more computer processing components may select a UE for instruction at random, however, in other aspects, the UE is selected for instruction based on one or more considerations. The one or more considerations may include one or more KPIs, such as one or more SINR, RSRQ, RSSI or RSRP values. For example, in selecting the UE, the one or more computer processing components may select UEs having a RSSI value less than a predetermined RSSI threshold (e.g., −70, −80, −90, or −100 dBm)—which may prioritize UEs with relatively weaker connections to the terrestrial RAN. The one or more considerations may include the type of session the UE has with the base station and/or the amount of bandwidth associated with the type of session. For example, UEs in short messaging service (SMS) messaging sessions may be selected over UEs in voice call sessions. The one or more considerations may include a distance between the UE and the base station exceeding a pre-determined distance threshold. At a third step 330, the one or more computer processing components may instruct the UE of the plurality of UEs to disconnect from the base station.

In aspects, the duration of the connection between the UE and the one or more nodes of the non-terrestrial RAN and/or the duration of the communication between the UE and the non-terrestrial RAN may comprise a first time period, wherein the first time period is configurable by the terrestrial RAN operator or the non-terrestrial operator. The first time period may be determined based on the type of session of the UE. In aspects, the first time period may be a first duration when the UE has a first session type or a second duration when the UE has a second session type. In such aspects, the second duration may be longer than the first duration. For example, the first session type may be a web browsing session and the second session type may be a data upload or download session. In this example, the data upload or download session may require more time to complete one or more requests associated with the data upload or download session, and thus, the duration of the connection (i.e., the second duration) is longer than if the UE had a web browsing session (i.e., the first duration). In another example, neither the first session type nor the second session type are voice call sessions. The duration of the first time period may be defined and/or altered by a change in session type (e.g., a SMS session changes to a voice call session).

The first time period may have a duration based on the utilization of the one or more nodes of the non-terrestrial RAN (e.g., the non-terrestrial network 208 of FIG. 2) and/or the utilization of the base station (e.g., the terrestrial base station 230 of FIG. 2). In aspects, the first time period is a duration necessary for the utilization of the base station to no longer exceed the pre-determined threshold. For example, the traffic congestion that caused the UE to connect with the non-terrestrial RAN may be reduced such that the UE may reconnect to the base station. In aspects, the first time period has a duration extending until a utilization the one or more nodes of the non-terrestrial RAN exceeds a pre-determined threshold. Once the first time period has expired, the UE may reconnect to the base station (or another base station of a terrestrial network).

As described with respect to the second step 320, the UE may be instructed to connect to one or more nodes of a non-terrestrial RAN. In aspects, the UE may be connected to a first node of the non-terrestrial RAN, but upon movement of the first node (e.g., where the node is a satellite that orbits the earth), the UE may no longer be located within a coverage area of the first node. In these instances, the UE may now be within a coverage of a second node and the session with the non-terrestrial RAN may be handed over to the second node of the non-terrestrial RAN.

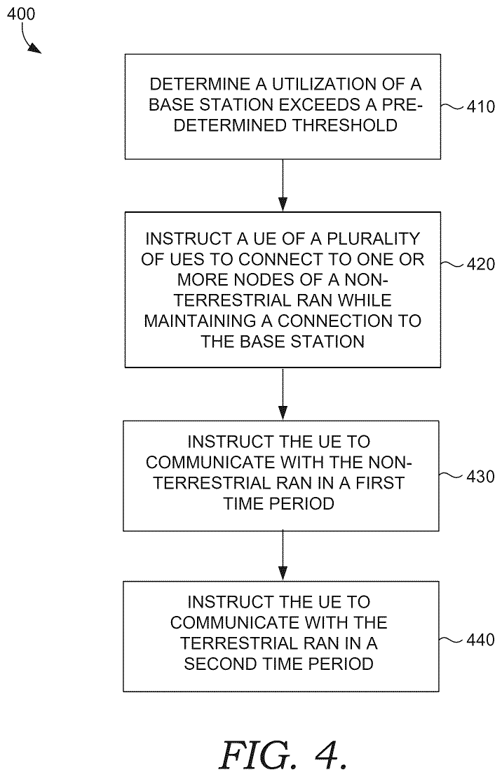

Turning now to FIG. 4, a flow chart representing a method 400 for switching between a terrestrial RAN (e.g., the terrestrial network 209 of FIG. 2) and a non-terrestrial RAN (e.g., the non-terrestrial network 208 of FIG. 2) is provided. The method 400 may be incorporated into a system having one or more of the components and/or features described with respect to FIGS. 2 and 3.

At a first step 410, one or more computer processing components may determine a utilization of a base station (e.g., the terrestrial base station 230 of FIG. 2) exceeds a pre-determined threshold. The utilization of the base station may be determined to exceed a pre-determined threshold based on a performance metric associated with wireless connections between the base station and one or more UEs, and/or based on actual usage of radio frequency resources at the base station, as described with respect to one or more aspects of FIG. 3.

At a second step 420, the one or more computer processing components may instruct a UE of a plurality of UEs to connect to one or more nodes of a non-terrestrial RAN while maintaining a connection to the base station. In aspects, the instruction and selection of the UE to connect to one or more nodes of the non-terrestrial RAN includes one or more aspects described with respect to FIG. 3. In maintaining the connection to the base station, even after the UE connects to the non-terrestrial base station, the UE may switch between each connection to maximize the user experience. At a third step 430, the one or more computer processing components may instruct the UE to communicate with the non-terrestrial RAN in a first time period. In aspects, the first time period includes one or more aspects described with respect to the first time period of FIG. 3.

At a fourth step 440, the one or more computer processing components may instruct the UE to communicate with the terrestrial RAN in a second time period. In aspects, the second time period reflects the duration of the connection between the UE and the base station of the terrestrial RAN and/or the duration of the communication between the UE and the terrestrial RAN. The second time period may be determined based on the type of session of the UE. In aspects, the second time period may be a first duration when the UE has a first session type or a second duration when the UE has a second session type. In such aspects, the second duration may be longer than the first duration. For example, the first session type may be a web browsing session and the second session type may be a data upload or download session. In this example, the data upload or download session may require more time to complete one or more requests associated with the data upload or download session, and thus, the duration of the connection (i.e., the second duration) is longer than if the UE had a web browsing session (i.e., the first duration). The duration of the second time period may be defined and/or altered by a change in session type (e.g., a SMS session changes to a voice call session).

The second time period may have a duration based on the utilization of the base station and/or a utilization of the one or more nodes of the non-terrestrial RAN. In some aspects, the second time period is a duration necessary for the utilization of the one or more nodes of the non-terrestrial RAN to no longer exceed a pre-determined threshold. For example, the first time period may have expired due to the utilization of the one or more nodes of the non-terrestrial RAN exceeding a pre-determined threshold, and during the second time period, this utilization no longer exceeds the pre-determined threshold, resulting in the expiration of the second time period. In other aspects, the second time period is a duration proceeding until the utilization of the base station again exceeds the pre-determined threshold. For example, the traffic congestion that caused the UE to connect with the non-terrestrial network may have been reduced such that the UE could switch to the connection with the base station during the second time period, however, when the traffic congestion of the base station returns and/or increases above the pre-determined threshold, the second time period may expire.

Once the second time period has expired, the UE may switch back to the non-terrestrial RAN. In aspects, the method 400 may further include the one or more computer processing components instructing the UE to communicate with the one or more nodes of the non- terrestrial RAN for a third time period. In such aspects, the third time period is subsequent to the second time period. The third time period may include one or more aspects of the first time period as described with respect to FIGS. 3 and 4. The UE may continue to switch back and forth between the terrestrial RAN and the non-terrestrial RAN based on the considerations influencing each of the first, second, and third time periods.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for switching between a terrestrial radio access network (RAN) and a non-terrestrial RAN, the system comprising:
a base station of a terrestrial RAN configured to wirelessly communicate with a plurality of user equipments (UEs) in a first coverage area; and
one or more computer processing components configured to perform operations comprising:
determine a utilization of the base station exceeds a pre-determined threshold;
instruct a UE of the plurality of UEs to connect to one or more nodes of the non-terrestrial RAN while maintaining a connection to the base station, wherein the one or more nodes are configured to wirelessly communicate with the UE in at least a portion of the first coverage area;
instruct the UE to communicate with the non-terrestrial RAN in a first time period; and
instruct the UE to communicate with the terrestrial RAN in a second time period, the second time period being subsequent to the first time period.

2. The system of claim 1, wherein the operations further comprise:
instruct the UE to communicate with the one or more nodes of the non-terrestrial RAN for a third time period, the third time period being subsequent to the second time period.

3. The system of claim 2, wherein a duration of the first time period is determined based on a session type of the UE.

4. The system of claim 3, wherein the first time period comprises a first duration or a second duration, wherein the first duration is associated with a first session type and the second duration is associated with a second session type, wherein the second duration is longer than the first duration.

5. The system of claim 4, wherein the first session type is a web browsing session and the second session type is a data upload or download session.

6. The system of claim 2, wherein a duration of the first time period is determined based on the utilization of the base station.

7. A system for connecting to a non-terrestrial RAN, the system comprising:
a base station of a terrestrial RAN configured to wirelessly communicate with a plurality of user equipments (UEs) in a first coverage area; and
one or more computer processing components configured to perform operations comprising:
determine a utilization of the base station exceeds a pre-determined threshold; and
instruct a UE of the plurality of UEs to connect to one or more nodes of the non-terrestrial RAN, wherein the one or more nodes are configured to wirelessly communicate with the UE in at least a portion of the first coverage area, and wherein a duration of a connection between the UE and the one or more nodes of the non-terrestrial RAN comprises a first time period.

8. The system of claim 7, wherein a duration of the first time period is determined based on a session type of the UE.

9. The system of claim 7, wherein the first time period comprises a first duration or a second duration, wherein the first duration is associated with a first session type and the second duration is associated with a second session type, wherein the second duration is longer than the first duration.

10. The system of claim 9, wherein the first session type is a web browsing session and the second session type is a data upload or download session.

11. The system of claim 7, wherein a duration of the first time period is determined based on the utilization of the one or more nodes of the non-terrestrial RAN.

12. The system of claim 7, wherein a duration of the first time period is determined based on the utilization of the base station no longer exceeding the pre-determined threshold.

13. The system of claim 7, the utilization of the base station is a signal to interference noise ratio (SINR) exceeding a pre-determined SINR threshold.

14. The system of claim 7, wherein the utilization of the base station is a reference signal received power (RSRP) exceeding a pre-determined RSRP threshold.

15. The system of claim 7, wherein the UE of the plurality of UEs is selected based on a distance between the UE and the base station exceeding a pre-determined distance threshold.

16. A system for offloading to a non-terrestrial RAN, the system comprising:
a base station of a terrestrial RAN configured to wirelessly communicate with a plurality of user equipments (UEs) in a first coverage area; and
one or more computer processing components configured to perform operations comprising:
determine a utilization of the base station exceeds a pre-determined threshold;
instruct a UE of the plurality of UEs to connect to one or more nodes of the non-terrestrial RAN, wherein the one or more nodes are configured to wirelessly communicate with the UE in at least a portion of the first coverage area; and
instruct the UE of the plurality of UEs to disconnect from the base station.

17. The system of claim 16, wherein the UE of the plurality of UEs is selected based on one or more key performance indicators (KPIs) of the UE exceeding one or more pre-determined KPI thresholds.

18. The system of claim 17, wherein the UE of the plurality of UEs is selected based on a received signal strength indicator (RSSI) received by the UE from the base station exceeding a pre-determined RSSI threshold.

19. The system of claim 16, wherein the UE of the plurality of UEs is selected based on a type of session between the UE and the base station.

20. The system of claim 16, wherein the utilization of the base station is a number of resource blocks exceeding a pre-determined resource block threshold.
